(19) United States
(12) Patent Application Publication
(10) Pub. No.: US 2024/0210202 A1
(43) Pub. Date: Jun. 27, 2024

(54) SYSTEM AND METHOD FOR DETERMINING DIFFICULTY FACTOR FOR GEOGRAPHIC ZONES

(71) Applicant: HERE Global B.V., Eindhoven (NL)

(72) Inventor: Priyank SAMEER, Mumbai Maharashtra (IN)

(21) Appl. No.: 18/087,446

(22) Filed: Dec. 22, 2022

(51) Int. Cl. G01C 21/00; G01C 21/20

(52) U.S. Cl. CPC G01C 21/3804; G01C 21/20

(57) ABSTRACT

A system, a method, and a computer program product may be provided for determining a difficulty factor for a geographic zone. The system, for example, identifies the geographic zone within a geographic area. The geographic zone includes at least two physical structures within a predefined proximity. The system determines structural information for each of the at least two physical structures. The structural information comprises at least height information and length information for each of the at least two physical structures. The system, then, determines a difficulty factor associated with the geographic zone based on the determined structural information. The system, then, updates a map database based on the difficulty factor.

### TECHNOLOGICAL FIELD

The present disclosure generally relates to routing and navigation systems, and more particularly relates to systems and methods for determining difficulty factor for geographic zones for routing and navigation of aerial vehicles.

### BACKGROUND

Navigation applications generally rely on data stored in a map database for identifying various navigation related entities such as obstacles detection, navigation instructions, and the like. In case of an aerial vehicle, accurate detection of navigation related entities becomes more important to ensure safe and reliable operation of the aerial vehicle. Aerial vehicles may be used for several commercial applications. For example, the aerial vehicles may be used for last mile delivery of packages, such as medical supplies, food or other goods. To conduct such last mile delivery operation, the aerial vehicles may require navigation instructions to travel from a departure point to a destination point.

However, navigation through certain areas may have its complexities. Such complexities may arise due to varying dimensions of different infrastructures present around such areas. For example, navigation through certain areas (referred to as geographic zones, hereinafter) in urban spaces may be difficult due to the presence of densely packed tall buildings. Therefore, accurate identification of such geographic zones is crucial for efficient and safe navigation of aerial vehicles.

### BRIEF SUMMARY

A system, a method, and a computer program product are provided herein that focuses on determining a difficulty factor for a geographic zone accurately and update it on map data, for providing accurate, safe, and reliable navigation assistance.

In one aspect, a system for determining a difficulty factor for a geographic zone is disclosed. The system comprises a memory configured to store computer-executable instructions; and one or more processors (hereinafter referred as processor) configured to execute the computer-executable instructions to identify a geographic zone within a geographic area. Further, the geographic zone includes at least two physical structures within a predefined proximity. The processor is further configured to determine structural information for each of the at least two physical structures. Further, the structural information comprises at least height information and length information for each of the at least two physical structures. The processor is further configured to determine a difficulty factor associated with the geographic zone based on the determined structural information. The processor is further configured to update a map database based on the difficulty factor.

In additional system embodiments, the processor is further configured to determine a height difference between the height information of the at least two physical structures. The processor is further configured to determine the difficulty factor based on the height difference. Further, the determined difficulty factor is greater than a predefined threshold when the height difference is greater than a height threshold.

In additional system embodiments, the processor is further configured to determine a length difference between the length information of the at least two physical structures. The processor is further configured to determine the difficulty factor based on the length difference. Further, the determined difficulty factor is greater than a predefined threshold when the length difference is less than a length difference threshold and the length information of each of the at least two physical structures is greater than a length threshold.

In additional system embodiments, the processor is further configured to determine restriction information for the geographic zone based on the structural information, the restriction information indicates a level of restriction of the geographic zone from one or more sides by the at least two physical structures. The processor is further configured to determine the difficulty factor based on the restriction information.

In additional system embodiments, the processor is further configured to obtain geographic area information based on the map database. The processor is further configured to identify the geographic zone within the geographic area based on the geographic area information.

In additional system embodiments, the processor is further configured to obtain vehicle attributes associated with an aerial vehicle. Further, the vehicle attributes comprises at least: resource information and load information of the aerial vehicle. The processor is further configured to determine energy consumption information for navigation of the aerial vehicle through the geographic zone based on the difficulty factor and the vehicle attributes. The processor is further configured to generate navigation instructions for the navigation of the aerial vehicle based on the energy consumption information. Further, the generated navigation instructions include an alternative flight path for the navigation of the aerial vehicle when the determined energy consumption information is greater than a predefined energy threshold.

In additional system embodiments, the processor is further configured to obtain cluster information of a cluster of aerial vehicles. The processor is further configured to determine cluster navigation information for navigation of the cluster of aerial vehicles through the geographic zone based on the cluster information and the difficulty factor. Further, the cluster navigation information comprises at least one of: flight time information, flight sequence information, or energy consumption information. The processor is further configured to generate navigation instructions for the navigation of the cluster of aerial vehicles based on the cluster navigation information.

In additional system embodiments, the structural information for the at least two physical structures further comprise at least one of: a set of images, location information, outline information, shape information, dimension information, periphery information, rooftop information, shadow information, open area information, or an identifier.

In another aspect, a method for detecting a geographic zone is provided. The method comprises identifying a geographic zone within a geographic area, the geographic zone includes at least two physical structures within a predefined proximity. The method further comprises determining structural information for each of the at least two physical structures. Further, the structural information comprises at least height information and length information for each of the at least two physical structures. The method further comprises determining a difficulty factor associated with the geographic zone based on the determined structural information. The method further comprises updating a map database based on the difficulty factor. Further, the determined difficulty factor is greater than a predefined threshold when the height difference is greater than a height threshold.

In additional method embodiments, the method further comprises determining a length difference between the length information of the at least two physical structures. The method further comprises determining the difficulty factor based on the length difference. Further, the determined difficulty factor is greater than a predefined threshold when the length difference is less than a length difference threshold and the length information of each of the at least two physical structures is greater than a length threshold.

In additional method embodiments, the method further comprises obtaining vehicle attributes associated with an aerial vehicle, the vehicle attributes comprising at least: resource information and load information of the aerial vehicle. The method further comprises determining energy consumption information for navigation of the aerial vehicle through the geographic zone based on the difficulty factor and the vehicle attributes. The method further comprises generating navigation instructions for the navigation of the aerial vehicle based on the energy consumption information.

In additional method embodiments, the method further comprises obtaining cluster information of a cluster of aerial vehicles. The method further comprises determining cluster navigation information for navigation of the cluster of aerial vehicles through the geographic zone based on the cluster information and the difficulty factor. Further, the cluster navigation information comprises at least one of: flight time information, flight sequence information, or energy consumption information. The method further comprises generating navigation instructions for the navigation of the cluster of aerial vehicles based on the cluster navigation information.

In yet another aspect, a computer program product comprising a non-transitory computer readable medium having stored thereon computer executable instructions which when executed by at least one processor, cause the processor to conduct operations for detecting a geographic zone, the operations comprise identifying a geographic zone within a geographic area, the geographic zone includes at least two physical structures within a predefined proximity. Further, the operations comprise determining structural information for each of the at least two physical structures. Further, the structural information comprises at least height information and length information for each of the at least two physical structures. Further, the operations comprise determining a difficulty factor associated with the geographic zone based on the determined structural information. Further, the operations comprise updating a map database based on the difficulty factor.

In additional computer program product embodiments, the operations further comprise determining a height difference between the height information of the at least two physical structures. Further, the operations comprise, determining a length difference between the length information of the at least two physical structures. Further, the operations comprise determining the difficulty factor based on the height difference and the length difference.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates an environment comprising a system implemented for determining a difficulty factor of a geographic zone, in accordance with one or more example embodiments;

FIG. 2 illustrates an exemplary block diagram of a system for determining a difficulty factor of a geographic zone, in accordance with one or more example embodiments;

FIG. 3 illustrates an exemplary geographic area, in accordance with one or more example embodiments;

FIG. 4 illustrates another exemplary geographic area, in accordance with one or more example embodiments;

FIG. 5A illustrates another exemplary geographic area having a geographic zone, in accordance with one or more example embodiments;

FIG. 5B illustrates another exemplary geographic area having a geographic zone, in accordance with one or more example embodiments;

FIG. 6 illustrates an exemplary geographic area, in accordance with one or more example embodiments;

FIG. 7 illustrates a flowchart for implementation of an exemplary method for determining a difficulty factor for a geographic zone, in accordance with one or more example embodiments;

FIG. 8 illustrates an exemplary geographic area having a geographic zone , in accordance with one or more example embodiments;

FIG. 9 illustrates a flowchart for implementation of an exemplary method for determining a difficulty factor of a geographic zone, in accordance with one or more example embodiments; and

FIG. 10 illustrates a flowchart for implementation of an exemplary method for determining a difficulty factor of a geographic zone, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “aerial vehicle” may refer to an autonomous, semi-autonomous or manual automotive vehicle that may use one or more electric motors for propulsion above ground surface, i.e., in air. In an example, the electric motors may be powered or propelled by electricity from extravehicular sources or a battery system. In an example, an aerial vehicle may use a traction battery pack to power the electric motor. For example, the battery pack may be plugged to a power outlet or charging equipment, for charging. For example, the aerial vehicle may include charging port, battery pack, converters, one or more electric motors, charger, controller, cooling system, and transmission connects. In an example, the aerial vehicle may be an unmanned aerial vehicle, such as a drone. Throughout the present disclosure, the term “aerial vehicle” is used interchangeably with “drones”.

The term “physical structure” may refer to an object or a construction that may occupy space. In an example, the physical structure may be a permanent structure, and/or a natural structure. In an example, the physical structure may be a point of interest (POI) building, such as a hospital, a residential building, a commercial building, a factory, a government building, and so forth. Examples of the physical structure may include, but are not limited to, building, mobile tower, bridge, monument, mountain, and the like.

The term “geographic zone(s)” or “zone(s)” may refer to area which comprises two or more physical structures within a predefined proximity. The two or more physical structures has substantial height or length difference, such that, the aerial vehicle has to exert considerably extra energy to pass through them. As mentioned above, the physical structures may include, but are not limited to, buildings, mountains, bridges, electric or communication tower, or the like. For example, the geographic zone may be formed between two or more physical structures, such that a spatial area of the geographic zone may form a part of a route of a vehicle. In an example, the “geographic zone(s)” or “zone(s)” may be an area that an aerial vehicle may have to travel through when navigating from a departure point to a destination point. Further, the term “geographic zone(s)” or “zone(s)” may be used interchangeably with “cornering zone” and “cornering area”.

The term “route” may refer to a planned or a developed path that may be used by an aerial vehicle to reach from one point, such as a departure point to another point, such as a destination point. The route may include, for example, roads, lanes, links, air space, and so forth.

The term “object” refers to all types of items and/or packaging suitable for delivery or carrying and may be known by other terms including but not limited to cargo, freight, payload, goods, package, parcel, box, bag, shrink-wrap, blister pack, electronic device, or some combination thereof.

### End of Definitions

A system, a method, and a computer program product are provided herein in accordance with an example embodiment for determining a difficulty factor for a geographic zone.

The system, the method, and the computer program product disclosed herein may be configured to enable reliable and efficient navigation of vehicles, such as aerial vehicles, through cornering areas. The system may be configured to identify a geographic zone that may be a cornering area, or a cornering zone formed between two of more physical structures. Further, the system may be configured to determine structural information for the physical structures associated with the geographic zone. Thereafter, the system may be configured to determine a difficulty factor for the geographic zone based on the determined structural information. In particular, the system may determine the difficulty factor for the geographic zone based on the structural information associated with the physical structure. Based on the difficulty factor, map data may be updated to locate the geographic zone on a route. The system, the method, and the computer program product disclosed herein may be configured to identify such cornering areas, i.e., the geographic zone and determine a difficulty factor for the geographic zone. The difficulty factor may be used for generating or updating navigation instructions for the aerial vehicle for safe and efficient navigation thereof.

In an example, the identification and other information relating to the geographic zone may be used for updating a map database. Subsequently, operations of aerial vehicles, such as delivery of food, medicines, packages, etc. may be performed more effectively. For example, based on the identified geographic zone, a navigation route of an aerial vehicle may be updated. In certain cases, the aerial vehicle is able to avoid getting stuck in a cornering area, such as the geographic zone, thereby saving battery charge during due course of operation. This may prevent failure of the aerial vehicle and improve efficiency of aerial vehicle-based delivery operations. In addition, identification of the difficulty factor for the geographic zone may be used for planning smart city efficiently.

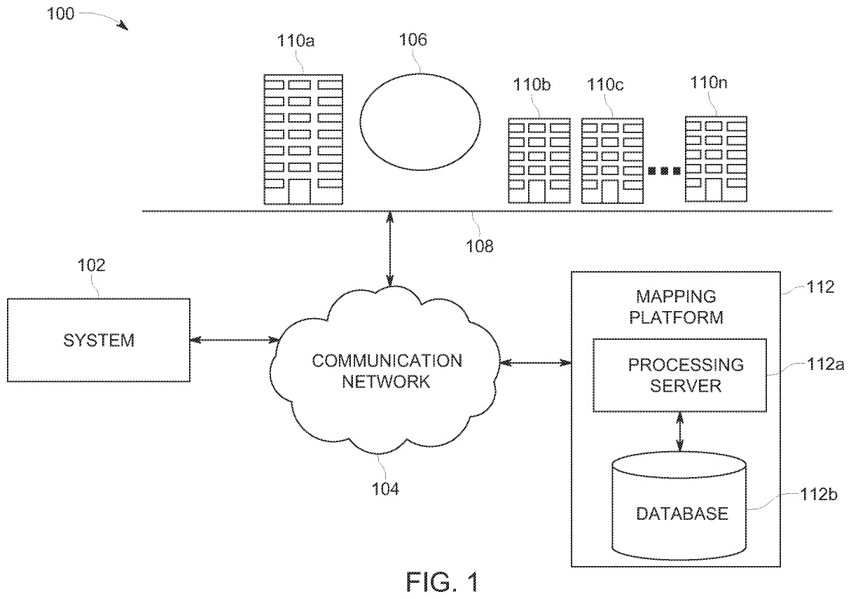

FIG. 1 illustrates an environment 100 comprising a system 102 implemented for determining a difficulty factor of a geographic zone, in accordance with an example embodiment.

As illustrated in FIG. 1, the environment 100 may comprise the system 102, a communication network 104, a geographic zone 106, a geographic and/or three-dimensional ground area 108, a plurality of physical structures (depicted as physical structures 110a, 110b, 110c, 110n), and a mapping platform 112. The mapping platform 112 may further include a processing server 112a and a database 112b. Additional, fewer, or different components may be provided. For example, a proxy server, a name server, a map server, a cache server or cache network, a router, a switch or intelligent switch, a database, additional computers or workstations, administrative components, such as an administrative workstation, a gateway device, a backbone, ports, network connections, and network interfaces may be provided. While the components in FIG. 1 are shown as separate from one another, one or more of these components may be combined. In this regard, the system 102 may be communicatively coupled to the components shown in FIG. 1 to conduct the desired operations and wherever required modifications may be possible within the scope of the present disclosure.

In urban or semi-urban areas, there might a number of physical structures within close proximity. Due to large variation in dimensions of the physical structures, a zone (namely, geographic zone) of certain complexity or difficulty level may be formed between two or more physical structures, such as the geographic zone 106 is formed between the physical structure 110a and the physical structure 110b. In certain cases, controlling navigation of an aerial vehicle within the geographic zone 106 may be difficult due to narrow space between the physical structure 110a and the physical structure 110b. In another example, the navigation of an aerial vehicle within the geographic zone 106 may be difficult as the aerial vehicle may have to expend extra battery charge or energy to get out of the geographic zone 106.

To this end, route planners and/or the aerial vehicle should have knowledge of such geographic zone in advance for efficient route planning and reliable navigation. In an example, after locating the geographic zone 106 on a map, aerial vehicles may avoid such geographic zone for a safe and efficient flight. In another example, the aerial vehicle may travel through such geographic zone 106 only under favorable conditions, such as when the aerial vehicle has sufficient battery charge, when the geographic zone 106 substantially reduces length of a route to be travelled, etc. For example, navigation service providers may use information of the geographic zone 106 to find reliable and efficient route and optimize navigation of aerial vehicles to ensure successful operation of aerial vehicles through cornering areas like the geographic zone 106. To address the aforesaid technical challenges, the system 102 of FIG. 1 introduces a capability to identify the geographic zone 106. In an example, the system 102 obtains geographic area information relating to a geographic area from on the database 112b. For example, the geographic area may be a locality, a city, a state, and so forth.

In an example, the system 102 may be coupled with the mapping platform 112, via the communication network 104. In an embodiment, the system 102 may be coupled to one or more communication interfaces, for example, as a part of a routing system, a navigation app, and the like.

All the components in the environment 100 may be coupled directly or indirectly to the communication network 104. The components described in the environment 100 may be further broken down into more than one component and/or combined together in any suitable arrangement. Further, one or more components may be rearranged, changed, added, and/or removed. In an example embodiment, the system 102 may be the processing server 112a of the mapping platform 112 and therefore may be co-located with or within the mapping platform 112.

In accordance with an embodiment, the database 112b may be configured to receive, store, and transmit data that may be collected from vehicles travelling throughout one or more geographic areas having the physical structures 110a-110n and the geographic zone 106.

The system 102 may comprise suitable logic, circuitry, and interfaces that may be configured to identify the geographic zone 106 and update map data for facilitating navigation of aerial vehicles.

In operation, the system 102 is configured to identify the geographic zone 106 within a geographic area. For example, the system 102 may obtain geographic area information relating to the geographic area from a map database, such as the database 112b. The geographic area may include the physical structures 110a-110n. As may be noted, the physical structures 110a-110n are built over the geographic and/or three-dimensional ground 108 area and may occupy space vertically to the ground. Moreover, there may be a spatial region vertically above the ground, i.e., in an air space, which may be bounded between the physical structures 110a-110n. For example, a spatial region bounded by two physical structures within a predefined proximity, such as the physical structures 110a and 110b may be identified as the geographic zone 106. In an example, the physical structures 110a and 110b may surround the geographic zone 106 from two sides. It may be noted that the geographic zone 106 is also bounded by the ground area 108 from one side, such as a third side.

It may be understood that the embodiments of the present example describe the geographic zone 106 formed by two physical structures. However, this is not construed as a limitation. In other examples of the present disclosure, the geographic zone 106 may be bounded by more than two physical structures from more than two sides. For example, a geographic zone may be bounded by three physical structures from three sides, four physical structures from four sides, three physical structures from two sides such that two physical structures may be at a same side, and so forth.

Pursuant to present example, the geographic zone 106 is a vertically steep geographic zone formed due to significant difference in heights of the physical structures 110a and 110b. In such a case, aerial vehicles may get stuck in the geographic zone 106 and they will require more energy to get out of the geographic zone 106 due to a vertical ascend while travelling from the physical structure 110b to cross over the physical structure 110a. In another example, not depicted in the present FIG. 1, a geographic zone may be a horizontally extended geographic zone formed due to long lengths of physical structures bounding it, and aerial vehicles may consume more energy to cross the entire length of the geographic zone.

The system 102 is configured to determine structural information for each of the physical structures 110a and 110b forming the geographic zone 106. In an example, the structural information comprises at least height information and length information for each of the physical structures 110a and 110b. In an example, the height information may include a height of each of the physical structures 110a and 110b and the length information may include a length of each of the physical structures 110a and 110b. The structural information may also include other information relating to the physical structures 110a and 110b, such as other dimensional information, boundary information, consent information, geographic data, and so forth.

The system 102 is configured to determine the difficulty factor for the geographic zone 106 based on the determined structural information. The difficulty factor is a measure of difficulty in crossing the geographic zone 106 for aerial vehicles. The difficulty factor helps to identify if crossing the geographic zone 106 is feasible or not for the aerial vehicles. In an example, a value of the difficulty factor may be in range 0 to 1. Further, the system 102 is configured to update the database 112b based on the difficulty factor. Navigation instructions may be generated based on the updated map data indicating the difficulty factor of the geographic zone 106. As a result, the generated navigation instructions may ensure safe navigation of the aerial vehicles through the geographic zone 106.

These and other embodiments of the present disclosure are explained in further detail in conjunction with following figures.

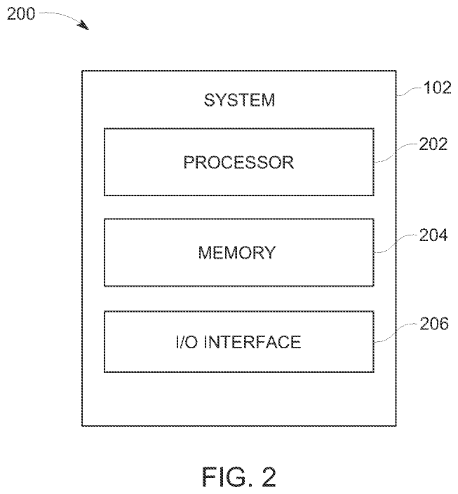

FIG. 2 illustrates an exemplary block diagram 200 of the system 102, in accordance with one or more example embodiments. FIG. 2 is explained in conjunction with FIG. 1.

The system 102 may include at least one processor 202, a memory 204, and an I/O interface 206. In accordance with an embodiment, the system 102 may retrieve data from the database 112b associated with the system 102.

In an example embodiment, the processor 202 may identify the geographic zone 106. The processor 202 may identify the geographic zone 106 with help of geographic area information comprising location information and building information of the physical structures 110a and 110b.

Further, the processor 202 collects and/or analyzes data from the memory 204, and/or any other data repositories available over the communication network 104 to determine the difficulty factor associated with the geographic zone 106.

The I/O interface 206 may provide outputs for end user to view the identified cornering areas, such as the geographic zone 106 and difficulty factor of the geographic zone 106. In an example embodiment, the I/O interface 206 may present information relating to location of the geographic zone 106 on a map, where an aerial vehicle may get stuck. Thereafter, based on the location of the geographic zone 106, an aerial vehicle may avoid the geographic zone 106 and may find an alternate route. It is further noted that the I/O interface 206 may operate over the communication network 104 to facilitate the exchange of information.

The above presented components of the system 102 can be implemented in hardware, firmware, software, or a combination thereof. Though depicted as a separate entity in FIG. 1, it is contemplated that the system 102 may be implemented as a module of any of the components of the mapping platform 112.

The processor 202 may retrieve computer executable instructions that may be stored in the memory 204 for execution of the computer executable instructions. In accordance with an embodiment, the processor 202 may be configured to retrieve input, such as real-time sensor data, historical probe data, real-time probe data, map data, geographic area information, and aerial vehicle information; and give output, such as navigation instructions, notification associated with flying and/or landing for use by the end user, through the I/O interface 206.

The processor 202 of the system 102 may be configured to identify the geographic zone 106. The processor 202 may be configured to use ML models to identify the geographic zone 106. Further, the processor 202 may be configured to determine structural information for the physical structures 110a, 110b in the geographic zone 106. The structural information comprises at least height information and length information for each of the physical structures 110a and 110b. Further, the processor 202 may be configured to determine a difficulty factor associated with the geographic zone 106 based on the determined structural information. The processor 202 may be further configured to update map data on the map database to route planning based on the difficulty factor of the geographic zone 106.

The memory 204 of the system 102 may be configured to store a dataset that may include information, such as, but not limited to, the geographic area information, probe data, sensor data, building data, and map data. In accordance with an embodiment, the memory 204 may include processing instructions for processing the data. The dataset may include real-time data and historical data, from service providers.

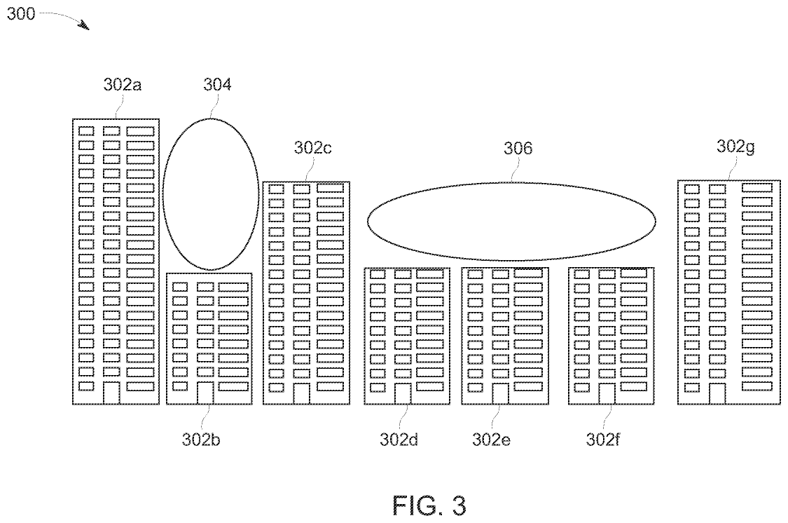

FIG. 3 illustrates an exemplary geographic area 300, in accordance with an example embodiment. The geographic area 300 includes a plurality of physical structures, depicted as plurality of physical structures 302a, 302b, 302c, 302d, 302e, 302f, and 302g (also referred to hereinafter as physical structures 302a-302g). In an example, the physical structures 302a-302g may be buildings. The physical structures 302a-302g may form cornering areas or zones therebetween. In an example, if at least two buildings are within a predefined proximity, a geographic zone may be formed.

To this end, the system 102 may obtain geographic area information relating to the geographic area 300. The geographic area information may include building information and location information relating to the physical structures (referred to as buildings, hereinafter) 302a-302g. Based on the geographic area information, the system 102 may identify a geographic zone 304 bounded by the buildings 302a, 302b and 302c from three sides; and a geographic zone 306 bounded by the buildings 302c, 302d, 302e, 302f and 302g from three sides. It may be noted that the geographic area 300 may include other buildings or physical structures and a plurality of geographic zones, such as the geographic zone 304 and the geographic zone 306. In an example, the system 102 may determine physical structures or buildings that may be within a predefined proximity from each other. In case two or more buildings are within the predefined proximity, an air space between them may be identified as a cornering area or a cornering zone. Pursuant to present example, the system 102 may perform operations for determining difficulty factor for the geographic zone 304 and the geographic zone 306.

For example, the geographic zone 304 and the geographic zone 306 may be a cornering zone. It may be noted that the term “geographic zone” is used interchangeably with the term “cornering zone”.

Based on the geographic area information, the system 102 may determine structural information of the buildings 302a-302g. In an example, the system 102 may determine dimensional information of the buildings 302a-302g. Based on the structural information of the buildings 302a-302g, the system 102 may determine the difficulty factor for the geographic zone 304 and the geographic zone 306. The structural information comprises at least height information, length and breadth information for each of the buildings 302a-302g. In an example, the system 102 may determine the difficulty factor based on height information of the buildings 302a-302g.

In an example, the system 102 may determine location information relating to each of the buildings 302a-302g based on the geographic area information. For example, the location information may include geographic coordinates for each of the buildings 302a-302. Based on the location information relating to each of the buildings 302a-302g, the system 102 may determine a distance between two buildings, for example, proximity between the buildings 302a and 302b, 302b and 302c, 302a and 302c, 302c and 302d, and so forth. Further, the system 102 may determine the difficulty factor for the geographic zone 304 and the geographic zone 306 based on the proximity between two buildings. For example, if proximity or ground distance between the buildings 302a, 302b and 302c is less, such as less than 10 meters, the geographic zone 304 may be narrow. Thus, the system 102 may determine that the geographic zone 304 formed between the buildings 302a, 302b and 302c has a high difficulty factor.

In an example, the system 102 may determine height differences between the buildings such as 302a and 302b, 302b and 302c, and 302a and 302c, and the like, based on the height information of the buildings. Similarly, the system 102 may determine height differences between height of the buildings 302c and 302d, 302d and 302e, 302e and 302f, 302f and 302g, and 302c and 302g based on the height information of the buildings 302c, 302d, 302e, 302f, and 302g. Based on the height differences, the system 102 may determine the difficulty factor for the geographic zone 304 and the geographic zone 306. In an example, the height information of the buildings 302a-302g indicate height of the buildings 302a-302g on a vertical axis, for example, from a base or bottom of the buildings 302a-302g to a corresponding top. Therefore, a height difference between two buildings, such as the buildings 302a and 302b may correspond to a difference in the heights of the buildings 302a and 302b. For example, the height difference may be equal to a length or a vertical distance from a top of the building 302b to a top of the building 302a.

It may be noted that the height of the building 302a is more than the height of building 302b. Also, the height of the building 302c is more that height of the building 302b. Therefore, height difference between the buildings 302a and 302b, and 302b and 302c is large. Moreover, the large variation in the height is spread across a small distance on a horizontal axis. Further, due to the large height difference and less gap between the buildings 302a, 302b and 302c, the difficulty factor for the geographic zone 304 bounded by the buildings 302a, 302b and 302c may be high. Therefore, the difficulty factor may be greater than a predefined threshold when the height differences between the buildings 302a and 302b, and 302b and 302c is greater than a height threshold. In other words, the difficulty factor is high or is greater than the predefined threshold when the height differences between the buildings 302a and 302b, and 302b and 302c is large or greater than the height threshold. Due to high difficulty factor, an aerial vehicle may have to expend a large amount of energy in getting out of the geographic zone 304.

In an example, the height threshold for height difference may be set manually or may be determined dynamically based on the height information. In an example, the difficulty factor may be a score within a range of 0 to 1. In such a case, the predefined threshold may be set as 0.4. For example, the height difference between the buildings 302a and 302b may be 25 meters, and the height difference between the buildings 302b and 302c may be 20 meters. Further, the height threshold may set as 10 meters. Therefore, as the height difference between the buildings 302a, 302b and 302c is greater than the height threshold, the difficulty factor for the geographic zone 304 may be greater than the predefined threshold indicating that an aerial vehicle may get stuck in the geographic zone 304 or may face difficulty in getting out of the geographic zone 304.

In an example, the height threshold may be set as a percentage of change in height of buildings. Further, the difficulty factor for the geographic zone 304 and 306 may be determined based on a % in change of height of a building with respect to height of adjacent buildings. In an example, if a % of change of height of a building with respect to height of an adjacent building is at least 25%, then the difficulty factor may be high or greater than the predefined threshold. Owing to the presence of heighted buildings 302a and 302c and huge height variation between height of the buildings 302a, 302b and 302c, the urban zone 304 may have high difficulty factor. For example, a % of change for height of the buildings 302a and 302b is more than 25% and a % of change for height of the buildings 302b and 302c is also more than 25%. Therefore, the difficulty factor for the geographic zone 304 is greater than the predefined threshold. However, due to presence of same heighted buildings 302d, 302e, and 302f in the geographic zone 306, the % of change for height of the buildings 302c and 302d, 302d and 302e, 302e and 302f, and 302f and 302g may be less than 25%. Therefore, the geographic zone 306 may have low difficulty factor, i.e., less than the predefined threshold.

Continuing further, the height difference between the building 302c and 302d, and 302f and 302g may be large; however, the height difference between buildings 302d, 302e, and 302f is small. Moreover, the large variation in the height is spread across a large distance on a horizontal axis. Therefore, the difficulty factor of the geographic zone 306 may be low, for example, lower than the difficulty factor of the geographic zone 304. For example, the difficulty factor for the geographic zone 306 may be less than the predefined threshold and/or less than the difficulty factor of the geographic zone 304. The difficulty factor is less for the geographic zone 306 as compared to the geographic zone 304, because it is seen that variation in height among the buildings 302c-302g is less steep and more distributed over area as compared to variation in height among the buildings 302a-302c having steep height difference distributed in smaller area. In this manner, based on the height difference between the height information of at least two physical structures, the system 102 determines the difficulty factor associated with a geographic zone.

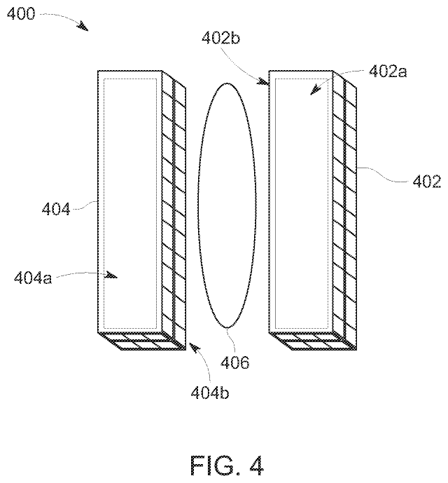

FIG. 4 illustrates another exemplary geographic area 400, in accordance with an example embodiment. The geographic area 400 may include two buildings 402 and 404, and a geographic zone 406. The two buildings 402 and 404 are parallel to each other. It may be noted that the buildings 402 and 404 may have a top side 402a and 404a, respectively. The buildings 402 and 404 may have longitudinal sides 402b and 404b, respectively. For example, the top side 402a and 404a may correspond to a terrace or a roof. Further, the geographic zone 406 is a longitudinally extending region between the buildings 402 and 404. For example, the geographic zone 406 may be bounded from two longitudinal sides 402b and 404b of the buildings 402 and 404 and from a bottom side by ground. Such depiction of the geographic zone 406 confined from two sides by the two buildings 402 and 404 is only exemplary and should not be construed as a limitation.

The system 102 may be configured to determine structural information of the buildings 402 and 404. For example, the system 102 may determine dimensional information of the buildings 402 and 404, such as height or depth information, length information, width information, shape, construction type, and the like. In an example, the system 102 may determine a height difference between the two buildings 402 and 404. For example, the system 102 may determine a height difference between the buildings 402 and 404 based on the height information of the buildings 402 and 404. Thereafter, the system 102 may determine a length difference between the buildings 402 and 404 based on the length information of the buildings 402 and 404. In addition, the system 102 may also compare length information of each of the buildings 402 and 404 with a length threshold.

For example, when the height difference may be less, i.e., less than a height threshold and the length difference may be less, i.e., less than a length difference threshold then the system 102 may compare the length information of each of the buildings 402 and 404 with the length threshold. In an example, the length threshold and the length difference threshold may be set manually or may be determined dynamically. In an example, the length difference threshold may be determined dynamically based on a % of change in length. For example, the length difference threshold may be 25%. Moreover, the length threshold may if a building extending across a long longitudinal area. For example, the length threshold may a distance of length of building, such as 10 meters, 20 meters, and so forth. In this regard, if a % of change for a length of the building 402 with respect to a length of the building 404 is less than 25% and the length of the buildings 402 and 404 is greater than 20 meters, then the geographic zone 406 between them will have a high difficulty factor. In other words, the geographic zone 406 will have a difficulty factor higher than the predefined threshold, due to long area of the geographic zone 406 bounded between the long buildings 402 and 404 having less % of change in length.

It may be noted that a length of the geographic zone 406 is determined as a longitudinal distance between two buildings, i.e., buildings 402 and 404, and a length difference between the two buildings 402 and 404 may be determined as a difference in a length of one building, such as the building 402 and a length of another building, such as the building 404.

Based on the structural information of the buildings, the system 102 may determine the difficulty factor for the geographic zone 406. For example, the system 102 may determine that the difficulty factor for the geographic zone 406 is high if the length information of the buildings 402 and 404 indicates that length of the buildings 402 and 404 is greater than the length threshold, while the height difference between the buildings 402 and 404 is less than the height threshold and the length difference between the buildings 402 and 404 is less than the length difference threshold. In this regard, the difficulty factor for the longitudinally extending geographic zone 406 may be greater than a predefined threshold, i.e., high, as an aerial vehicle may have to expend extra energy to get out of the geographic zone 406 by travelling across an entire length of the geographic zone 406. As it is seen that the height difference between the two buildings 402 and 404 is not significant. Therefore, the system 102 may be configured to determine the difficulty factor based on the length information and the length difference of the two buildings 402 and 404.

In an example, height of the buildings 402 and 404 may be 17 meters and 20 meters, respectively; and length of the buildings 402 and 404 may be 47 meters and 50 meters, respectively For example, the height difference between the buildings 402 and 404 may be 3 meters and the length difference may be 3 meters. To this end, the height difference may be less than the height threshold of 10 meters, and the length difference may be less than the length difference threshold of 12 meters. Thereafter, the length of the buildings 402 and 404 may be compared with the length threshold of 15 meters. As the length of the buildings 402 and 404 is greater than the length threshold, the difficulty factor may be determined to be greater than a predefined threshold. For example, a value of the difficulty factor may be in a range of 0 to 1. Moreover, the predefined threshold may be set as 0.5. In this regard, the difficulty factor of the geographic zone 406 may be greater than 0.5.

To that end, for the difficulty factor associated with the geographic zone 406 to be greater than the predefined threshold, two conditions must be satisfied. The first condition being the length difference of the at least two buildings must be less than the length difference threshold. The second condition being length information of each of the at least two buildings bounding the geographic zone 406 should be greater than the length threshold. To this end, in practical application, when length information of each of the two buildings 402 and 404 will be greater than the length threshold, aerial vehicles will have to travel a longer distance. Also, when the length difference of the at least two buildings is less than the length difference threshold, the aerial vehicles may not be able to get out of the geographic zone 406 from an end side of a building having less length. For this reason, when these two conditions are satisfied for the geographic zone 406, the difficulty factor associated with the geographic zone 406 may be determined as high or greater than the predefined threshold. In this manner, the system 102 may determine the difficulty factor for geographic zones based on the length difference, the height difference, the length information and the height information.

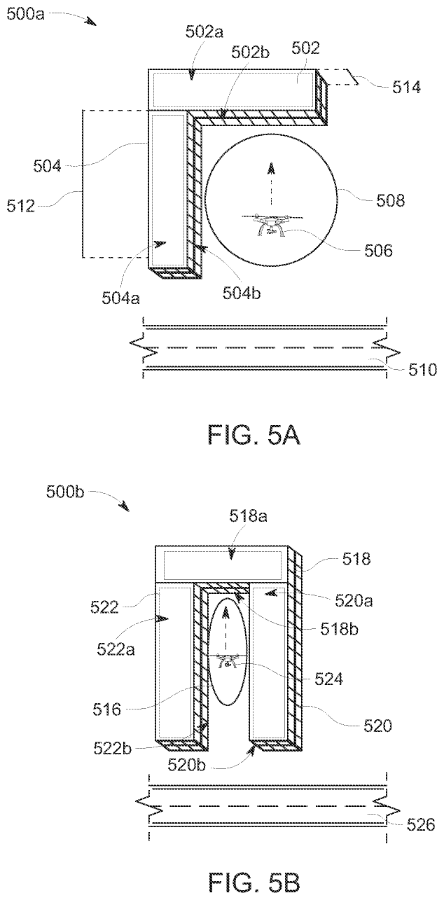

FIG. 5A illustrates an exemplary geographic area 500a having a geographic zone 508, in accordance with an example embodiment. The geographic area 500a includes two buildings 502 and 504, an aerial vehicle 506, the geographic zone 508, and a link 510. The buildings 502 and 504 may have a top side 502a and 504a, respectively. For example, the top side 502a and 504a may be roof of the buildings 502 and 504, respectively. The buildings 502 and 504 may have a longitudinal side 502b and 504b, respectively. For example, the sides 502b and 504b may be front side, back side, right side, or left side of the buildings 502 and 504. Further, the geographic zone 508 is a spatial region between the buildings 502 and 504. As shown, the two buildings 502 and 504 are adjacent to each other, such that the building 502 is located at one end side of the building 504. The buildings 502 and 504 are within a predefined proximity and the geographic zone 508 is formed in an air space in front of the side 504b of the building 504 and side 502b of the building 502.

In an example, the geographic zone 508 is bounded by the building 504 from a left side and the building 502 from a front side. The aerial vehicle 506 may be travelling on a path from the link 510 towards the building 502. In order to get out of the geographic zone 508, the aerial vehicle 506 may have to travel across a length 512 of the side 504b of the building 504 and a height 514 of the building 502.

In one example embodiment, the system 102 may be configured to determine restriction information for the geographic zone 508 based on the structural information of the buildings 502 and 504. In an example, the system 102 may determine the restriction information for the geographic zone 508 based on a number of sides from which the geographic zone 508 is surrounded or bounded. The restriction information indicates a level of restriction of the geographic zone 508 from one or more sides by the two buildings 502 and 504. As may be noted, the geographic zone 508 is bounded by the two buildings 502 and 504 from two sides. However, such depiction of the bounding of the geographic zone 508 in only exemplary and there may be more than two buildings/physical structures present around the geographic zone 508.

In one example, the restriction information may be a percentage, a grade, a score, and the like. As the geographic zone 508 is surrounded by two sides, for example, the restriction information may be a score, such as 2, a percentage, such as 50 percent, and the like. In an example, the restriction level is determined based on restriction of the geographic zone 508 from four sides, such as right side, left side, front side and back side. In other words, restriction on top or bottom side of a geographic zone may not be considered for determining the restriction level as it may be assumed that the bottom side would be bounded by at least ground area, or any building and the top side is open for vertical acceleration of the aerial vehicle 106.

The system 102 is configured to determine the difficulty factor for the geographic zone 508 based on the restriction information. Based on the restriction information, and the structural information of the buildings 502 and 504, the difficulty factor is determined. In an example, if the restriction level is high, such as greater than a restriction threshold, then the difficulty factor may be high. Moreover, the system 102 may determine a height difference between a height of the buildings 502 and 504 and determine the difficulty factor for the geographic zone 508 based on the height difference.

In an example, the system 102 may assign a weight to each of different parameters, such as height difference, restriction level, length difference, length information, height information, and other parameters used for determining the difficulty factor. It may be noted that since the buildings 502 and 504 are not parallel to each other and do not form a bounded longitudinal area therebetween, therefore, a weight for the comparison between the length information and a length difference for the buildings 502 and 504 may be low. As a result, the determined difficulty factor may not be determined based on the length information.

Based on the difficulty factor of the geographic zone 508, the aerial vehicle 506 may choose its path, i.e., to travel through the geographic zone 508 or not. In one example, the operational performance of the aerial vehicle 506 is limited due to dependence on battery consumption. Subsequently, the aerial vehicle 506 may have to conserve battery during operation. To this end, the aerial vehicle 506 should take the shortest path which requires less energy consumption.

FIG. 5B illustrates another exemplary geographic area 500b having a geographic zone 516, in accordance with one or more example embodiments. The geographic area 500b includes three buildings 518, 520 and 522, an aerial vehicle 524, the geographic zone 516, and a link 526. The buildings 518, 520 and 522 may have a top side 518a, 520a and 522a, respectively. The buildings 518, 520 and 522 may have a longitudinal side 518b, 520b and 522b, respectively. For example, the sides 518b, 520b and 522b may be front side, back side, right side, or left side of the buildings 518, 520 and 522, respectively. Further, the geographic zone 516 is a spatial region between the buildings 518, 520 and 522. As shown, the building 518 is adjacent to the buildings 520 and 522, and the buildings 520 and 522 are parallel to each other. In this regard, the buildings 518, 520 and 522 are within a predefined proximity and the geographic zone 516 is formed in an air space in front of the side 518b of the building 518 and between the sides 520b and 522b of the buildings 520 and 522, respectively.

In an example, the geographic zone 516 is bounded by the building 522 from a left side, the building 520 from a right side and the building 518 from a front side. The aerial vehicle 524 may be travelling on a path from the link 526 towards the building 518, such that the aerial vehicle 524 may enter the geographic zone 516. In order to get out of the geographic zone 516, the aerial vehicle 524 may have to travel across a length of the sides 520b and 522b of the buildings 520 and 522 respectively, and a height of the building 518.

Further, the system 102 may be configured to determine restriction information for the geographic zone 516 based on the structural information of the buildings 518, 520 and 522. As the geographic zone 516 is bounded by the three buildings 518, 520 and 522 from three sides, for example, the restriction information may be a score, such as 3, a percentage, such as 75 percent, and the like.

The system 102 is configured to determine the difficulty factor for the geographic zone 516 based on the restriction information. Based on the restriction information, and the structural information of the buildings 518, 520 and 522, the difficulty factor is determined. Pursuant to present example, the restriction level of the geographic zone 516 is high, such as greater than a restriction threshold. Further, the system 102 may determine height difference between adjacent buildings, such as the buildings 518 and 520, and 518 and 522. The system 102 may also determine length difference between parallel buildings, such as the buildings 520 and 522; and compare length information of the buildings 520 and 522 with a length threshold. For example, if the height difference is high or greater than a height threshold, then the difficulty factor may be high. Moreover, if the length difference is less than a length difference threshold and the length information or length of the buildings 520 and 522 is long or greater than the length threshold, then the difficulty factor may be high. In addition, if the restriction level of the geographic zone 516 is high, for example, greater than 40 percent, then the difficulty factor may be high. For example, the system 102 may determine the difficulty factor for the geographic zone 516 based on the restriction level, the height difference, the length difference and the length information.

Based on the determined difficulty factor of the geographic zone 516, the system 102 may update the map data in the database 112b. For example, the aerial vehicle 524 may retrieve the updated map data to generate navigation instructions. In certain cases, the aerial vehicle 524 may also generate steps for navigating through the geographic zone 516, based on the difficulty factor and/or other attributes relating to the geographic zone 516 that may be stored in the map data. Subsequently, the aerial vehicle 524 may be able to navigate through the geographic zone 516 reliably or avoid the geographic zone 516 and choose an alternative path.

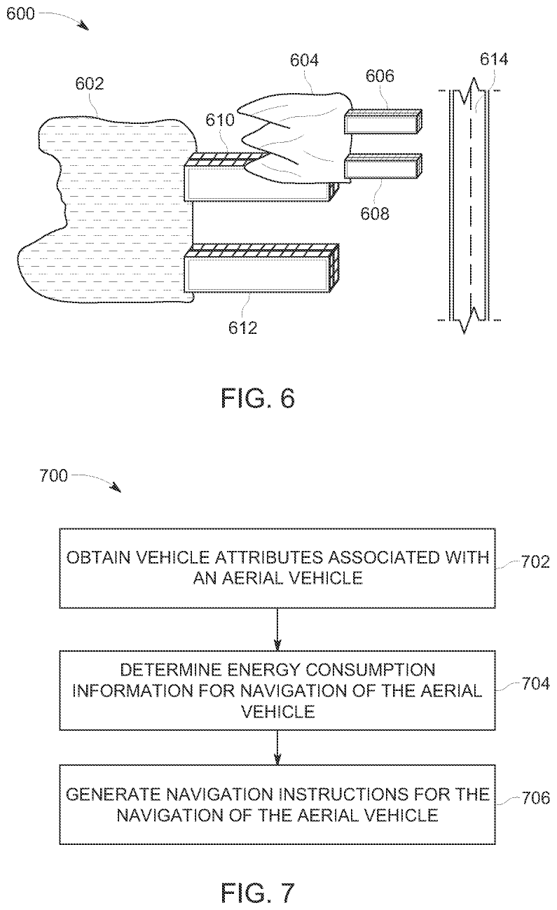

FIG. 6 illustrates an exemplary geographic area 600, in accordance with an example embodiment. The geographic area 600 includes a plurality of physical structures. The plurality of physical structures includes, but is not limited to, a water body 602, a hilly terrain 604, and a plurality of buildings (depicted as buildings 606, 608, 610 and 612). The geographic area 600 also includes a link 614. Pursuant to the present embodiment, the system 102 may identify geographic zones or cornering zones within the geographic area 600. As may be noted, such geographic zones may be formed between two or more physical structures, wherein the two or more physical structures are within a predefined proximity. The system 102 may determine a difficulty factor for the geographic zones based on structural information of the plurality of physical structures, such as the water body 602, hilly terrain 604, and buildings 606-612.

In an example, the system 102 may determine structural information relating to the water body 602, hilly terrain 604 and the buildings 606-612. For example, the structural information relating to the water body 602 may include, but is not limited to, width of the water body 602, depth of the water body 602, height or elevation of the water body 602, area of the water body 602, and the like. Further, the structural information relating to the hilly terrain 604 may include, but is not limited to, length, height and width of the mountains in the hilly terrain 604, shape of hills in the hilly terrain 604, area covered by the hilly terrain 604, elevation of the hilly terrain 604, and so forth. The structural information relating to the buildings 606-612 may include, but is not limited to, length, height and width of the buildings 606-612, shape of the buildings 606-612, elevation of the buildings 606-612, and so forth.

The system 102 may determine difficulty factor for a geographic zone within the geographic area 600 based on structural information of physical structures surrounding the geographic zone.

In certain cases, a plurality of geographic zones may be formed in the geographic area 600. In such a case, the system 102 may determine difficulty factor for a geographic zone based on difficulty factor of adjacent or surrounding geographic zones as well. In certain cases, if the system 102 determines that multiple geographic zones in the geographic area 600 have high difficulty factor, then the system 102 may mark the geographic area 600 as a cornering geographic area. Subsequently, during navigation, aerial vehicles may avoid such geographic area 600 having multiple geographic zones with high difficulty factor.

FIG. 7 illustrates a flowchart for implementation of an exemplary method 700 for determining a difficulty factor for a geographic zone, in accordance with an example embodiment.

The method 700 may include, at step 702, obtaining vehicle attributes. In one example, the vehicle attributes are associated with an aerial vehicle, such as the aerial vehicle 506. For example, the aerial vehicle 506 may be a UAV or a drone. The vehicle attributes may include, but are not limited to, resource information and load information of the aerial vehicle 506. For example, the resource information may indicate information associated with energy resource such as current battery charge status or remaining battery charge, battery operation, battery life, and the like. Moreover, the load information may indicate information associated with an object or a cargo carried by the aerial vehicle and any other weight that the aerial vehicle 506 may be bearing. In an example, the load information may relate to, but are not limited to, size or dimensions of the aerial vehicle 506, weight of the aerial vehicle 506, weight of an object carried by the aerial vehicle 506, size or dimensions of the object, or a combination thereof.

The method 700 may further include, at step 704, determining energy consumption information for navigation of the aerial vehicle 506 through a geographic zone, such as the geographic zone 508. The energy consumption information may be determined based on a difficulty factor for the geographic zone 508 and the vehicle attributes of the aerial vehicle 506.

As may be noted that due to large height difference between two buildings, the aerial vehicle 506 may have to ascend along a vertical axis of a geographic zone to get out of the geographic zone. Alternatively, if a geographic zone is surrounded by long and parallel buildings from two sides, the aerial vehicle 506 may have to travel through an entire length of the parallel buildings. In such cases, the aerial vehicle 506 may consume additional or extra energy to get out of such geographic zones. Further, if a load or weight of an object carried by the aerial vehicle 506 is high, the energy consumption of the aerial vehicle 506 may further increase. In certain cases, the aerial vehicle 506 may fail to navigate through geographic zones successfully, for example, if battery charge of the aerial vehicle 506 drains rapidly during a vertical ascend, or the aerial vehicle may encounter a number of geographic zones during its journey. This may affect performance and operation of the aerial vehicle 506. Therefore, effective route planning is crucial to avoid such geographic zones and conserve battery health and charge of the battery of the aerial vehicle 506 to ensure efficient and reliable operation.

To overcome the above-mentioned problems, the system 102 may determine a difficulty factor for the geographic zone 508. A manner in which the difficulty factor is determined is described in detail in conjunction with the FIGS. 1-6. Further, the system 102 may estimate a total amount of energy that may be consumed by the aerial vehicle 506 during navigation through the geographic zone 508 based on the vehicle attributes and the difficulty factor. For example, the energy consumption of the aerial vehicle 506 is estimated based on the difficulty factor of the geographic zone 508 and the vehicle attributes, such as battery performance, battery charge status, weight of the aerial vehicle 506, weight of an object carried by the aerial vehicle 506, etc.

Continuing further, the method 800 may further include, at step 706, generating navigation instructions for the navigation of the aerial vehicle 506 based on the energy consumption information. In an example, the navigation instructions may be generated based on, but not limited to, current location and/or source location of the aerial vehicle 506, destination location, flight time, flight path, availability of charging resource, difficulty factor of different geographic zones along the flight path, energy consumption information relating to the different geographic zones etc. For example, the system 102 may check if the aerial vehicle 506 is able to travel from the source location to the destination location; and in some cases, such as last-mile delivery, back from the destination location to the source location reliably. It may be noted that the generated navigation instructions may be updated in real-time based on real-time conditions along the flight path of the aerial vehicle 506 and/or change n difficulty factor of any geographic zone along the flight path.

In one example, the generated navigation instructions may include an alternative flight path for the navigation of the aerial vehicle 506 when the determined energy consumption information is greater than a predefined energy threshold. In one example, when the aerial vehicle 506 has less battery charge or has a poor battery performance and difficulty factor of the geographic zone 508 is high, the generated navigation instructions may include an alternative path for the geographic zone 508. In this manner, the aerial vehicle 506 may be able to avoid the geographic zone 508. In another example, when the aerial vehicle 506 is carrying a heavy load and the difficulty factor of the geographic zone 508 is low, the generated navigation instructions may include a warning and/or an alternative path for the geographic zone 508. Subsequently, the aerial vehicle 506 may navigate through the alternative path or ensure sufficient battery charge before initiating the journey.

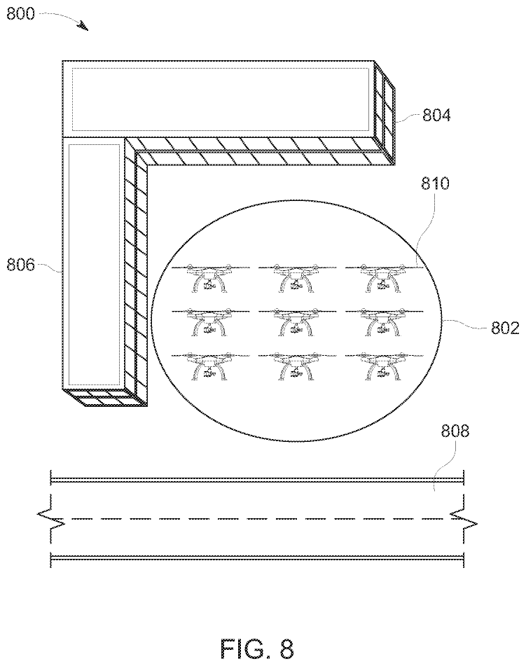

FIG. 8 illustrates an exemplary geographic area 800 having a geographic zone 802, in accordance with an example embodiment. The geographic area 800 includes two buildings 804 and 806, the geographic zone 802, and a link 808. In an example, a cluster of aerial vehicles 810 may be travelling or flying through the geographic area 800. The cluster of aerial vehicles 810 may include a plurality of aerial vehicles (referred to as drones, hereinafter). The drones may be spaced apart from each other by a predefined distance. The drones may include a mother drone and a plurality of child drones. For example, the child drones may follow the mother drone or operate based on instructions provided by the mother drone, during their operation. Moreover, the drones in the cluster of aerial vehicles 810 may have varying vehicle attributes, such as size, weight, weight of load, battery charge, battery performance, battery properties, etc. To this end, it is crucial to know if the cluster of aerial vehicles 810 (referred to as the cluster 810, hereinafter) can pass through the geographic zone 802.

In some cases, it may be crucial for the drones in the cluster 810 to travel together, such as in proximity from each other and/or the mother drone. Therefore, different flight paths for different drones of the cluster 810 may not be ideal. However, in a geographic zone where a cluster of aerial vehicles is travelling, there might be the possibility of an accident between drones due to absence of proper gaps between adjacent drones in the cluster. Therefore, flying the cluster from the geographic zones is risky.

In an instance where a geographic zone is long and narrow, only a few drones may be able to fly through the geographic zone at a time. In other words, some of the drones may have to wait in air before they can enter the geographic zone, and some of the drones may have to wait in the air after they exit from the geographic zone to re-gather the drones of the cluster 810. Due to such waiting, some drones may lose connection from peer child drones and/or the mother drone. In addition, the drones may waste their energy during the waiting period in addition to extra energy consumed during travel through the long geographic zone. In another instance, a geographic zone may be vertically steep, and therefore all the drones may have to vertically ascend to pass through the geographic zone. As different drones may have different vehicle attributes, therefore, energy consumption of the different drones while getting out of the geographic zone may be different. In some cases, certain drones may not have enough battery charge or battery performance for crossing the geographic zone, thereby causing failure of such drones in the geographic zone. As a result, the drones may meet an accident. This may cause loss of resource and failure of operation. To address the afore-mentioned problems, the system 102 may determine if navigation of the cluster 810 through the geographic zone 802 is feasible or not.

In an example, the system 102 may determine the difficulty factor for the geographic zone 802 based on the structural information of the buildings 804 and 806 forming the geographic zone 802. In an example, the system 102 may determine the difficulty factor based on length information of the buildings 804 and 806, length difference between length of the buildings 804 and 806, height information of the buildings 804 and 806, height difference between height of the buildings 804 and 806, restriction level, or a combination thereof.

Further, the system 102 may obtain cluster information of the cluster of aerial vehicles 810. For example, the cluster information may include vehicle attributes of drones of the cluster 810, and other cluster-related information, such as mother drone properties, separation area between drones, communication link between drones of the cluster 810, and so forth.

The system 102 may determine cluster navigation information for navigation of the cluster 810 through the geographic zone 802 based on the cluster information and the difficulty factor. The cluster navigation information may include, but is not limited to, flight time information, flight sequence information, or energy consumption information. For example, if the difficulty factor of the geographic zone 802 is high and the cluster information indicates that the number of drones is high or the drones do not have enough battery charge, then the cluster navigation information may indicate an increased flight time, a change in flight sequence (for example, splitting or dividing of the cluster 810 based on drones that get into the geographic zone 802 and that do not go into the geographic zone 802, or halt of some of the drones of the cluster 810 before they enter the geographic zone 802), and increased energy consumption of the drones.

In an example, the system 102 may determine a capacity of the geographic zone 802 based on the cluster information. Based on a total number of drones in the cluster 810, required space between the drones and required arrangement of the cluster 810, the system 102 may determine a number of drones that may fly through the geographic zone 802 during a predefined time period. Based on the capacity of the geographic zone 802, the system 102 may determine an effect of travel though the geographic zone 802 on each of the drones of the cluster 810. For example, the effect may be identified based on change in flight time, flight sequence and energy consumption of different drone, when travelling through the geographic zone 802 and when not travelling through the geographic zone 802. In some cases, the system 102 may determine the change in flight time based on a wait time for drones when travelling through the geographic zone 802.

Thereafter, the system 102 may generate navigation instructions for the navigation of the cluster 810 based on the cluster navigation information. In an example, if the cluster navigation information may indicate increased total flight time of the cluster 810, increased energy consumption of drones of the cluster 810 and/or change in flight sequence of the cluster 810, the system 102 may generate navigation instructions for the navigation of the cluster 810 using an alternative path. In some cases, the alternative path may enable the cluster 810 to avoid the geographic zone 802 completely. In some other cases, the alternative path may enable the cluster 810 to split and travel through the alternative path as well as the geographic zone 802, such that the wait time and the flight time of the cluster 810 are reduced. For example, such navigation instructions causing splitting of the cluster 810 may be generated only if such splitting may not cause any loss of communication amongst the drones, the operation of the cluster 810 is not affected by change in flight sequence, and any increase in energy consumption of some drones travelling through the geographic zone 802 does not affect the efficiency and safety of the drones.

In one example, the geographic zone 802 has a capacity of 5 drones to travel through it. However, in one example, the cluster 810 is of 10 drones that may have to travel through the geographic zone 802. In this case, the system 102 may generate navigation instructions for the cluster 810 to cause the cluster 810 to split in two parts to reduce flight time. As may be noted that clusters prefer to move together, so if the difficulty factor is high, the navigation instructions having an alternate route may be provided to the cluster 810. Therefore, based on the capacity of the geographic zone 802, the difficulty factor of the geographic zone 802, and the cluster information, the system 102 may generate navigation instructions for the cluster 810.

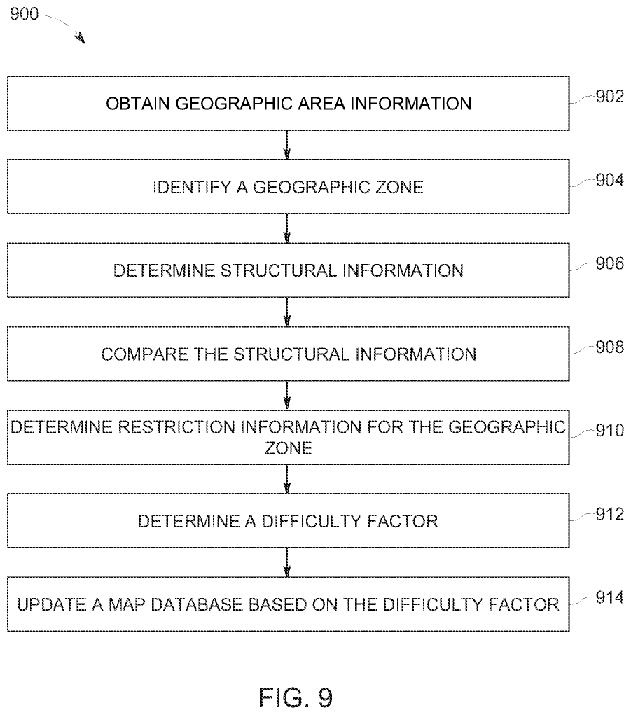

FIG. 9 illustrates a flowchart for implementation of an exemplary method 900 for determining a difficulty factor of a geographic zone, in accordance with an example embodiment.

The method 900 may include, at step 902, obtaining geographic area information. In one example the geographic area information is obtained from the database 112b. The database 112 may collect the geographic area information using, for example, probe vehicles, motion sensors, inertia sensors, image capture sensors, proximity sensors, LIDAR (light detection and ranging) sensors, ultrasonic sensors, and the like. The geographic area information may include information relating physical structures, such as buildings in a geographic area, location information relating to the buildings in the geographic area, and so forth.

The method 900 may further include, at step 904, identifying the geographic zone 106 within the geographic area based on the geographic area information. In one example, the geographic area includes at least two physical structures, such as the physical structures 110a and 110b that are within a predefined proximity from each other. For example, the geographic zone 106 may be identified as a spatial region between at least two physical structures 110a and 110b, such that the physical structures may surround the geographic zone 106 from at least two sides In an example, the two physical structures 110a and 110b may be 50 meters distance apart such that the geographic zone may be formed in the 50 meters between the two physical structures 110a and 110b.

The method 900 may further include, at step 906, determining structural information for each of the at least two physical structures 110a and 110b. In one example, the structural information comprises at least height information and length information for each of the at least two physical structures 110a and 110b. For example, the height information of the physical structures 110a and 110b may indicate a height of the two physical structures 110a and 110b in a vertical axis, such as an elevation above a ground level. Moreover, the length information of the physical structures 110a and 110b may indicate a length of the two physical structures 110a and 110b along a horizontal axis, such as a longitudinal distance extending across a longitudinal horizontal side of the physical structures 110a and 110b. For example, the structural information of the physical structures 110a and 110b may also include, but is not limited to, a set of images, location information, outline information, shape information, dimension information, periphery information, rooftop information, shadow information, open area information, and an identifier.

The method 900 may further include, at step 908, comparing the structural information. In an example, the height of the two physical structures 110 and 110b is compared to determine the height difference. The height difference between the at least two physical structures 110a and 110b is compared with a height threshold to determine if the height difference is high or low. Further, the length of the two physical structures 110 and 110b is compared to determine the length difference. The length difference between the at least two physical structures 110a and 110b is compared with a length difference threshold to determine if the length difference is high or low. Similarly, the length of the two physical structures 110 and 110b is compared with a length threshold

The method 900 may further include, at step 910, determining restriction information associated with the geographic zone 106. In one example, the restriction information may indicate a number of sides from which the geographic zone 106 is surrounded. For example, the restriction information may be a percentage, a grade, a score, and the like. For example, if the geographic zone 106 is surrounded by physical structures from two sides then the restriction level may be 50%; and if the geographic zone 106 is surrounded from three sides then the restriction level may be 75%.

The method 900 may further include, at step 912, determining difficulty factor. In one example, the difficulty factor is determined based on the structural information and the restriction information associated with the geographic zone 106. For example, if the height difference between the at least two physical structures 110a and 110b is greater than the height threshold, the difficulty factor may be high. In another example, the difficulty factor may be high if the length difference between the at least two physical structures 110a and 110b is less than the length difference threshold while the length information of each of the at least two physical structures 110a and 110b is greater than the length threshold. For example, if the length of each the two physical structures 110a and 110b is greater than 10 meters and the length difference between the two physical structures 110a and 110b is less than 5 meters, then the difficulty factor associated with the geographic zone 106 will be high. Also, the difficulty factor is determined using the restriction information. For example, if the restriction information indicates that the restriction level is high, the difficulty factor for the geographic zone 106 will also be high.

The method 900 may further include, at step 914, updating map database. In one example the map database is updated based on the determined difficulty factor associated with the geographic zone 106. The service providers may use the updated map database for generating navigation instructions for efficient navigation through the geographic zone 106. In an example, the navigation instructions may be generated for aerial vehicles, based on the updated map data having the difficulty factor information. Navigation instructions may be used for applications of aerial vehicles for last mile delivery of packages, medical supplies, food or other goods.

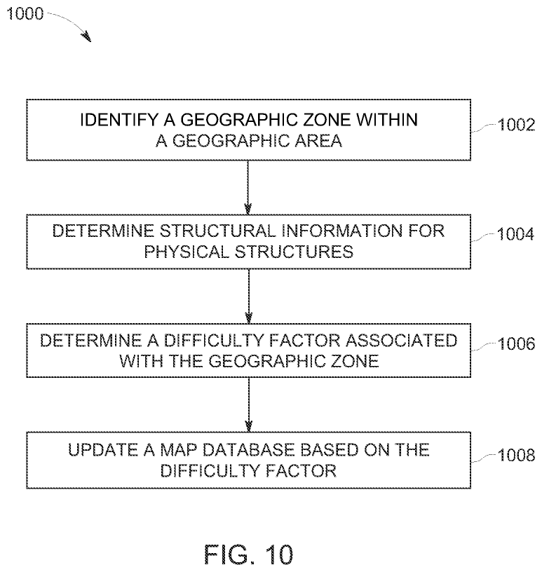

FIG. 10 illustrates a flowchart for implementation of an exemplary method 100 for determining a difficulty factor of a geographic zone, in accordance with one or more example embodiments.

The method 1000 may include, at step 1002, identifying the geographic zone 106 within a geographic area. In one example, the geographic zone 106 includes at least two physical structures 110a and 110b, such that the physical structures 110a and 110b are within a predefined proximity and bound the geographic zone 106 from two or more sides.

The method 1000 may further include, at step 1004, determining structural information for each of the at least two physical structures 110a and 110b. In one example, the structural information comprises at least height information and length information for each of the at least two physical structures 110a and 110b. In an example embodiment, the structural information of the at least two physical structures 110a and 110b may further include, for example, height, length, outline, shape, feature type, blueprint, identifier, and the like.

The method 1000 may further include, at step 1006, determining a difficulty factor associated with the geographic zone 106 based on the determined structural information. The structural information comprises the height information and length information for each of the at least two physical structures 110a and 110b. The difficulty factor is determined by comparing the height and length information of the each of the at least two physical structures 110a and 110b. In one example, the determined difficulty factor is greater than a predefined threshold when a height difference between the height of the physical structures 110a and 110b is greater than a height threshold. In another example, the determined difficulty factor is greater than a predefined threshold when a length difference between the length of the physical structures 110a and 110b is less than a length difference threshold and the length of each of the physical structures 110a and 110b is greater than a length threshold.

The method 1000 may further include, at step 1008, updating a map database based on the difficulty factor. In one example the map database is updated based on the determined difficulty factor associated with the geographic zone 106. In an example, route planning for navigation of aerial vehicles may be performed based on the difficulty factor to ensure safe and reliable operation of aerial vehicles and/or cluster of aerial vehicles. For example, the service providers may use the updated map database to generate navigation instructions for efficient navigation through the geographic zone 106.

Returning to FIG. 1, the communication network 104 may be wired, wireless, or any combination of wired and wireless communication networks, such as cellular, Wi-Fi, internet, local area networks, or the like. In some embodiments, the communication network 104 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In an example, the system 102 may be embodied as a cloud based service, a cloud based application, a cloud based platform, a remote server based service, a remote server based application, a remote server based platform, or a virtual computing system. In yet another example embodiment, the system 102 may be an OEM (Original Equipment Manufacturer) cloud. The OEM cloud may be configured to anonymize any data received by the system 102, before using the data for further processing, such as before sending the data to database 112b. In an example, anonymization of the data may be done by the mapping platform 112.

The mapping platform 112 may comprise suitable logic, circuitry, and interfaces that may be configured to store and process information. The mapping platform 112 may also be configured to store and update map data within the database 112b. The mapping platform 112 may include or may be configured to perform techniques related to, but not limited to, geocoding, routing (multimodal, intermodal, and unimodal), clustering algorithms, machine learning in location based solutions, natural language processing algorithms, and artificial intelligence algorithms. Data for different modules of the mapping platform 112 may be collected using a plurality of technologies including, but not limited to drones, sensors, connected cars, cameras, probes, and chipsets. In some embodiments, the mapping platform 112 may be embodied as a chip or chip set. In other words, the mapping platform 112 may comprise one or more physical packages (such as, chips) that includes materials, components and/or wires on a structural assembly (such as, a baseboard).

In some example embodiments, the mapping platform 112 may include the processing server 112a for conducting the processing functions associated with the mapping platform 112 and the database 112b for storing map data and other information. In an example, the database 112b may store geographic are information relating to geographic areas. In an embodiment, the processing server 112a may comprise one or more processors configured to process requests received from the system 102. The processors may fetch data, such as the geographic area information, map data, etc. from the database 112b and transmit the same to the system 102 in a format suitable for use by the system 102. The data may be collected from any sensor that may inform the mapping platform 112 or the database 112b of features within an environment of the geographic areas having physical structures. For example, motion sensors, inertia sensors, image capture sensors, proximity sensors, LIDAR (light detection and ranging) sensors, and ultrasonic sensors may be used to collect the data. In some example embodiments, as disclosed in conjunction with the various embodiments disclosed herein, the system 102 may be used to process the data for determining a difficulty factor for the geographic zone 106 between the two physical structures 110a and 110b.

In some example embodiments, the database 112b may also be configured to receive, store, and transmit other sensor data and probe data including positional, speed, and temporal data received from vehicles, such as aerial vehicles. The probe data may be used to determine traffic volume, such as air traffic volume, associated with movement of vehicles on or around the plurality of physical structures 110a and 110n. The traffic volume associated with the plurality of physical structures 110a and 110n may correspond to the vehicles travelling in the geographic zone 106 at a given time period. The probe count from the probe data may be observed within the given time period and projected to determine the traffic volume for that given time period. In accordance with an embodiment, the probe data may include, but are not limited to, real time speed (or individual probe speed), incident data, geolocation data, timestamp data, and historical pattern data.

The database 112b may further be configured to store the traffic-related data and topology and geometry-related data for a route network, road network, and/or an air space routes, as map data. The map data may also include cartographic data, routing data, and maneuvering data.

For example, the data stored in the database 112b may be compiled (such as into a platform specification format (PSF)) to organize and/or processed for identifying geographic zones, energy consumption in the these geographic zones, cost of navigation through these geographic zones, navigation success or fail and generate or update navigation-related entities and/or services, such as route calculation, route guidance, speed calculation, distance and travel time functions, navigation instruction generation, and other functions. The navigation-related entities may correspond to navigation through the geographic zone 106, re-routing of a route of operation, and other types of navigation functions. The compilation to produce the end user databases may be performed by a party or entity separate from the map developer. For example, a customer of the map developer, such as a navigation device developer or other end user device developer, may perform compilation on a received database 112b in a delivery format to produce one or more compiled navigation databases.

Returning to FIG. 2, the processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading. Additionally or alternatively, the processor 202 may include one or more processors capable of processing large volumes of workloads and operations to provide support for big data analysis. In an example embodiment, the processor 202 may be in communication with the memory 204 via a bus for passing information among components of the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to conduct various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA or the like, the processor 202 may be specifically configured hardware for conducting the operations described herein.

Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU) and logic gates configured to support operation of the processor 202. The network environment, such as, 100 may be accessed using the I/O interface 206 of the system 102. The I/O interface 206 may provide an interface for accessing various features and data stored in the system 102.

In some example embodiments, the I/O interface 206 may communicate with the system 102 and displays input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may comprise user interface circuitry configured to control at least some functions of one or more I/O interface elements such as a display and, in some embodiments, a plurality of speakers, a ringer, one or more microphones and/or the like. The processor 202 and/or I/O interface 206 circuitry may be configured to control one or more functions of one or more I/O interface 206 elements through computer program instructions (for example, software and/or firmware) stored on a memory 204 accessible to the processor 202.

In some embodiments, the processor 202 may be configured to provide Internet-of-Things (IoT) related capabilities to users of the system 102 disclosed herein. The IoT related capabilities may in turn be used to provide smart city solutions by providing real time navigation output, big data analysis, and sensor-based data collection by using the cloud based mapping system for determining the difficulty factor for the geographic zone. The I/O interface 206 may provide an interface for accessing various features and data stored in the system 102.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system comprising:
a memory configured to store computer executable instructions; and
one or more processors configured to execute the instructions to:
identify a geographic zone within a geographic area, wherein the geographic zone includes at least two physical structures within a predefined proximity;
determine structural information for each of the at least two physical structures, wherein the structural information comprises at least height information and length information for each of the at least two physical structures;
determine a difficulty factor associated with the geographic zone based on the determined structural information; and
update a map database based on the difficulty factor.

2. The system of claim 1, wherein the one or more processors are further configured to:
determine a height difference between the height information of the at least two physical structures; and
determine the difficulty factor based on the height difference.

3. The system of claim 2, wherein the determined difficulty factor is greater than a predefined threshold when the height difference is greater than a height threshold.

4. The system of claim 1, wherein the one or more processors are further configured to:
determine a length difference between the length information of the at least two physical structures; and
determine the difficulty factor based on the length difference.

5. The system of claim 4, wherein the determined difficulty factor is greater than a predefined threshold when the length difference is less than a length difference threshold and the length information of each of the at least two physical structures is greater than a length threshold.

6. The system of claim 1, wherein the one or more processors are further configured to:
determine restriction information for the geographic zone based on the structural information, wherein the restriction information indicates a level of restriction of the geographic zone from one or more sides by the at least two physical structures; and
determine the difficulty factor based on the restriction information.

7. The system of claim 1, wherein the one or more processors are further configured to:
obtain geographic area information based on the map database; and
identify the geographic zone within the geographic area based on the geographic area information.

8. The system of claim 1, wherein the one or more processors are further configured to:
obtain vehicle attributes associated with an aerial vehicle, the vehicle attributes comprising at least: resource information and load information of the aerial vehicle;
determine energy consumption information for navigation of the aerial vehicle through the geographic zone based on the difficulty factor and the vehicle attributes; and
generate navigation instructions for the navigation of the aerial vehicle based on the energy consumption information.

9. The system of claim 8, wherein the generated navigation instructions include providing an alternative flight path for the navigation of the aerial vehicle when the determined energy consumption information is greater than a predefined energy threshold.

10. The system of claim 1, wherein the one or more processors are further configured to:
obtain cluster information of a cluster of aerial vehicles;
determine cluster navigation information for navigation of the cluster of aerial vehicles through the geographic zone based on the cluster information and the difficulty factor, wherein the cluster navigation information comprises at least one of: flight time information, flight sequence information, or energy consumption information; and
generate navigation instructions for the navigation of the cluster of aerial vehicles based on the cluster navigation information.

11. The system of claim 1, wherein the structural information for the at least two physical structures further comprise at least one of: a set of images, location information, outline information, shape information, dimension information, periphery information, rooftop information, shadow information, open area information, or an identifier.

12. A method comprising:
identifying a geographic zone within a geographic area, wherein the geographic zone includes at least two physical structures within a predefined proximity;
determining structural information for each of the at least two physical structures, wherein the structural information comprises at least height information and length information for each of the at least two physical structures;
determining a difficulty factor associated with the geographic zone based on the determined structural information; and
updating a map database based on the difficulty factor.

13. The method of claim 12, the method further comprising:
determining a height difference between the height information of the at least two physical structures; and
determining the difficulty factor based on the height difference.

14. The method of claim 13, wherein the determined difficulty factor is greater than a predefined threshold when the height difference is greater than a height threshold.

15. The method of claim 12, the method further comprising:
determining a length difference between the length information of the at least two physical structures; and
determining the difficulty factor based on the length difference.

16. The method of claim 15, wherein the determined difficulty factor is greater than a predefined threshold when the length difference is less than a length difference threshold and the length information of each of the at least two physical structures is greater than a length threshold.

17. The method of claim 12, the method further comprising:
obtaining vehicle attributes associated with an aerial vehicle, the vehicle attributes comprising at least: resource information and load information of the aerial vehicle;
determining energy consumption information for navigation of the aerial vehicle through the geographic zone based on the difficulty factor and the vehicle attributes; and
generating navigation instructions for the navigation of the aerial vehicle based on the energy consumption information.

18. The method of claim 12, the method further comprising:
obtaining cluster information of a cluster of aerial vehicles;
determining cluster navigation information for navigation of the cluster of aerial vehicles through the geographic zone based on the cluster information and the difficulty factor, wherein the cluster navigation information comprises at least one of: flight time information, flight sequence information, or energy consumption information; and
generating navigation instructions for the navigation of the cluster of aerial vehicles based on the cluster navigation information.

19. A computer programmable product comprising a non-transitory computer readable medium having stored thereon computer executable instructions, which when executed by one or more processors, cause the one or more processors to conduct operations comprising:
identifying a geographic zone within a geographic area, wherein the geographic zone includes at least two physical structures within a predefined proximity;
determining structural information for each of the at least two physical structures, wherein the structural information comprises at least height information and length information for each of the at least two physical structures;
determining a difficulty factor associated with the geographic zone based on the determined structural information; and
updating a map database based on the difficulty factor.

20. The computer programmable product of claim 19, the operations further comprising:
determining a height difference between the height information of the at least two physical structures;
determining a length difference between the length information of the at least two physical structures; and
determining the difficulty factor based on the height difference and the length difference.
